(19) United States
(12) Patent Application Publication
(10) Pub. No.: US 2007/0208443 A1
(43) Pub. Date: Sep. 6, 2007

(54) Method For Determining Optimal Damping Treatments Layouts And Panel Shape Layouts

(75) Inventor: Davide Caprioli, Winterthur (CH)

Correspondence Address: NATH & ASSOCIATES, 112 South West Street, Alexandria, VA, 22314, US

(73) Assignee: RIETER TECHNOLOGIES AG., Winterthur (CH)

(21) Appl. No.: 10/576,132

(22) PCT Filed: Oct. 14, 2004
(86) PCT No.: PCT/EP04/11560

§ 371 Date: Dec. 18, 2006

(30) Foreign Application Priority Data
Oct. 15, 2003 (EP) 03023305.0

(51) Int. Cl. G06F 19/00

(52) U.S. Cl. 700/97

(57) ABSTRACT

The present invention is directed to an optirising method for vibration damping treatments and panel shape layouts of vehicle body structure parts in view of acoustic performance. This new optimisation tool is based on a genetic algorithm and is able to efficiently predict the optimum damping package on vehicle body panels in terms of materials, thickness and local damping distribution without the use of any experimental methodology for determining the vibration response. The present invention allows the efficient exploration of very large solution domains and has the possibility of taking into account high numbers of variables, even in full vehicle computations (metal sheet and damping treatment type, shape, thickness, temperature and distribution). The optimisation method according to the present invention has an open architecture, which makes it easy to modify and link to any simulation methodology.

The present invention relates to an optimisation and simulation CAE-method for determining optimal damping treatments layouts within structural body parts of vehicles, according to the preamble of claim 1.

The current trend in the automotive industry towards reductions of treatment weight and cost, along with increasing demands for shorter development time and improved vehicle Noise and Vibration Harshness (NVH) characteristics, dictates the necessity for design methodologies which allow efficient optimisation of vehicle body treatments. These methodologies are essential to shorten development time and achieve high performance treatment configurations. They can be embedded into vehicle Computer Aided Engineering (CAE) design flow and can then be used in providing design and platform component sharing guidance information before prototype vehicles are available.

There are many methods known to the man skilled in the art to optimise damping treatments for vehicles. Nevertheless all these methods are based on standard Design of Experiment Techniques and are commonly gradient-based methods. None of them can efficiently and reliably handle a higher number of optimisation variables.

From EP 1 177 950 it is known how to optimise the vibration damping. This method uses a vibration damping material which is applied only in areas of maximum vibrational response after having determined maximum points of vibration response. The vibrational response of each section of the vehicle components is scanned after exciting some vehicle component from one point. The disadvantage of this method is to be seen in the use of an experimental methodology for determining the vibration response. With the known method the damping material has to be applied on the areas with maximum vibrations, while the present invention looks to areas where the reduction of vibration shows a maximum overall effect, which is different than looking at the magnitude of the original vibrations.

A further well-known document in the field of optimization of passive damping treatments disclosing the efforts made in this field can be seen in the article XP008028067 from Trindade, Marcelo A.: “Optimization of sandwich/multilayer viscoelastic composite structure for vibration damping”, Proceedings of the 20^{th} International Conference on Offshore Mechanics and Arctic Engineering, OMAE2001, Volume 3, Materials, of Jun. 3-8, 2001, Rio de JS10045WOaneiro, Brazil, pages 257-264. This article discloses the use a Generic Algorithm to optimise the performance of visco-elastic damping treatments and is concerned with the damping of a sandwich/multilayer viscoelastic composite structure, in particular a composite base beam covered with a passive treatment comprising a viscoelastic layer between two composite laminates. The structure considered is just a sandwich beam discretised with a FE (finite element) code and has been developed to simulate layouts of this particular beam structure, and considers the laminated faces behaving as Bemoulli-Euler beams, while the behaviour of the core layer is calculated with Timoshenko hypothesis. This method is not suitable to optimise vibration damping treatments of vehicle body panels. The damping model used by this method is ADF (Anelastic Displacement Fields), where damping can be defined according to the excitation frequency. This method is based on the assumption that the temperature is constant and uniform all over the model and does not consider the temperature dependence of the different structure layers.

Furthermore the purpose of this method is the “geometrical” optimisation of passive damping treatments applied to laminated beams. “Geometrical” reflects the fact that just geometrical design variables are taken into account during the optimisation cycle. In fact, as far as the optimisation is concerned, only one design variable (thickness) of the visco-elastic layer is taken into account. With the proposed optimisation method—the only constrains are set on the damping weight and natural frequency variation—it is only possible to deal with structural-vibration (only raw averages all over the range of interest are taken into account), i.e. this method does not allow to take into account acoustic targets (as sound pressure level, SPL at a certain location).

Furthermore the method disclosed in this article only takes into account one single optimisation variable which is referring to the visco-elastic layer. In particular this method is concerned with the thickness of a predefined damping material only, i.e. this method does not allow to find or to select an optimal damping material. Moreover this method assumes fixed positions of the visco-elastic layer on the beam and does not consider a non-uniform temperature or material distribution, or other design variables of the composite layers.

Furthermore the optimisation targets presented in this article are based on the reduction of the structural-vibration. Two alternative objective functions are used therefore. The first one (equation 15) represents the sum of square-velocities over a time T, while the second (equation 16) represents the sum of the squared damping factors of the first five bending natural nodes. In addition penalty cost functions which refer to the added mass and structure properties modification are considered. No control on the quality of the improvement of the acoustical best solution in the spectrum of optimisation range is implemented.

It is the aim of present invention to achieve a stable optimisation and simulation CAE-method which overcomes the deficiencies of the known methods and is suitable to determine optimal damping treatments layouts and panel shape layouts for structural body parts (comprising frames and panels) subjected to structural loads, in particular to determine the optimal damping treatments and/or geometrical shape layouts of structural vehicle body frames or panels under a predefined loading condition, which method can efficiently and reliable handle a large number of variables.

This is achieved by a method comprising the features of claim 1, and in particular by using an optimisation tool named Genetic Optimisation for Lightweight Damping (GOLD). The foundations of this tool are based upon Genetic Algorithms. The user can take into account many different damping material types and damping material thicknesses, distributed on metallic body panels of different thicknesses as well as different temperature areas the damping package. The damping package optimisation process is automatically performed and controlled by the GOLD software. The user can interactively control the ongoing optimisation process and customise it by directly pre-setting special desired objectives and/or constraints, in terms of weight and NVH-performance (vibration or acoustic pressure), with simple interface commands.

The following makes clear that present invention overcomes the above mentioned deficiencies and distinguishes from known methods. In particular the typical structures considered when applying this tool or method are vehicle body FE models, that can be simulated with commercial FE codes (Nastran) that rely on the discretisation of the geometrical domain and solve numerically the wave equation in the frequency domain. The damping mechanism simulated here account for both bending, membrane and shear mechanism, to occur throughout the structure layers, but the added damping, mass, and stiffness effect of a damping pad applied on the steel structure is accounted for via a special equivalent material formulation. This Equivalent Material description, through the method called Emerald, is able to sintetyze the dynamic properties of a given multi-layer pileup in only one material description (Equivalent E_{bending}, Equivalent E_{membrane}, Equivalent loss factor membrane, Equivalent loss factor bending, Poisson, density). This equivalent method for the simulation of the damping effect is able to speed up the FE solution (helping in reducing the degrees of freedom of the model), and also to speed up the updating process of simulating a different damping distribution all over the FE body model. Moreover, this methods helps easily, as done in some works performed with GOLD, to take into account during an optimisation cycle a temperature distribution within the various area of the FE model, therefore addressing the right operational. efficiency of the damping material applied by the optimisation tool.

In addition the typical purpose of an optimisation carried out with GOLD, is to identify the “best” thickness and damping material that has to be applied per each potential location of a damping treatment. The optimisation tool as a result of its run, per predefined pool of potential damping materials) and which thickness, has be applid in order to achieve the committed targets. When speaking about targets, we've to take into account that not only structural-vibration targets can be considered, but also acoustic targets (SPL). Moreover, constrains and penalty functions can be applied, not only to the added damping weights, but also to address and link the improvements per each explored configuration on the complete response spectrum compared to the one of a reference configuration.

In addition, in the GOLD process, we've as many variables as many potential dampable areas it is possible to identify on the vehicle component/body. Each of these variables refer to a pool of potential damping treatment configuration, that each particular area can have. This means that the tool can be used to identify the optimal damping material and thickness and distribution map of damping layers over the component (this optimisation layout leads to a problem dimension with generally more than 20 design parameters).

In addition, the user is able to choose and customise several different Objective Function (OF) types, based on different quantities: NVH response (vibro-acoustic cost, etc.). Each of those quantities can be independently considered. In alternative, two or more of them can be combined according to different levels of importance, as the user wishes. That means, different quantities can be combined and each of them can be given a defined priority on the others and/or a defined assigned value and/or range to be used as a target. The basis of the OF description, is that any of these quantities are referred to the dynamic behaviour a “Reference damping treatment configuration” of the component/vehicle. In this way it is possible to qualitatively analyse the improvement, compared to the reference configuration, of each such-optimal configuration explored by the algorithms and also to apply constrain on the NVH performances using the spectrum of the reference configuration.

Present invention, named GOLD, is a new tool for the automatic optimisation of vehicle damping treatments. It is based upon Genetic Algorithms, which are recognised as the most powerful methodology to handle complex optimisation problems with very large numbers of possible discontinuous variables and exploits Finite Element (FE) and Boundary Element (BE) simulation techniques. The application field of this tool typically lies in the low-middle frequency range. The possible variables taken into account for the damping treatment optimisation can be:
panel material;
panel thickness;
damping treatment type;
damping treatment thickness;
panel area temperature; for instance, higher temperatures can be assigned to body panels in the tunnel or dash areas or a temperature distribution map derived from a thermal camera can be taken into account;
damping treatment local distribution.

In practice, GOLD can take into account a very high number of optimisation variables, which in theory would lead to a huge number of possible damping treatment configurations (typically billions) and efficiently handle optimisation problems practically impossible to be solved with standard Design of Experiments (DOE) techniques and gradient-based methods. The necessary starting input data for the optimisation are the following:
FE model of the structure (vehicle body) on which damping has to be optimised;
In case an acoustic target is required, BE (or FE) model of the passenger compartment;
Material parameters of all the possible damping treatments used in the optimisation;
Definition of the damping patches, i.e. the possible areas on the vehicle body panels where damping can be applied;
If required by the user, more additional constraints in terms of weight and NVH performance (vibration or acoustic pressure) can be defined.

In the beginning of the optimisation process, the total panel area where the designer decides damping can be applied is subdivided into a set of subareas, named damping patches. A damping patch is just a possible pad of damping treatment. “Possible” means that the patch can either be treated or not: GOLD can always take into account the possibility of leaving the patch bare. Each damping patch can carry a different combination of the above optimisation variables. Depending on the assembly or configuration of the damping patches, different damping packages are found. Damping treatments are included in the vehicle FE model by means of the Emerald methodology, starting from measured frequency and temperature dependent material properties. However GOLD may be linked to any damping simulation methodology.

Following a typically genetic evolution flow, the optimisation is performed in a cascade of selective iterations (generations). One damping package, named individual and coded as a binary string, is a possible solution of the optimisation problem. Each individual (binary string) corresponds to a treatment configuration of the body panels, i.e. a specific spatial distribution of selected damping treatments on the damping patches. At each generation step, the best performing individuals according to a defined objective function (OF) are selected. The group of individuals is then able to generate new individuals by means of genetic statistical operators embedded into GOLD, like, for instance, crossover (exchange of some bit sequences) between the selected individuals or mutation (bit change for an individual). According to a statistical selection, the best performing individuals have the highest chance to reproduce, while the worst performing individuals have a low reproduction probability or may even be discarded and replaced with new ones. The initial population is randomly selected and its individuals are very different. This means global exploration of the optimisation domain takes place in order to achieve the global OF maximum; unlike gradient-based optimisation techniques, the optimisation performed by GOLD is not stopped when a local maximum is found. The vibration and acoustical response calculation of an individual is automatically run by GOLD in case a potential optimum individual is found. In the end of the optimisation process, a group (population) of best individuals is kept in memory and the optimum damping package can be selected.

The user has the possibility of monitoring the whole optimisation process on a visual user-friendly control panel where the state of the optimisation is shown in real time with its main parameters, iteration by iteration. The explored solution space (i.e. the domain containing all the possible solutions) typically has a dimension of m^{N}, where
N is the number of possible damping patches
m is the number of possible treatment solutions

The final optimisation target is typically the reduction of the following quantities:
the damping package weight
the vibration response with respect to frequency
the acoustic response (Sound Pressure Level: SPL) with respect to frequency

The evaluation of the second quantity needs a structural FE run (i.e. Nastran)

The evaluation of the last quantity, whose procedure is described in the following lines, needs a structural FE run plus an acoustic BE or FE computation.

In general, transfer functions from attachment points on the car body to the interior are usually given as targets for the body acoustic performance. The transfer functions are typically in terms of p/Fⱼ where p is the sound pressure at the passengers' ear locations and Fⱼ is the force applied at the engine or suspension attachment points, in one direction. The p/Fⱼ transfer functions are calculated with a FE/BE uncoupled approach, which means that the fluid loading on the structure is neglected. The methodology can be divided into three main steps. In the first one, FE analysis is applied to calculate the vibration velocities vₖ at the nodes of the structure surrounding the cavity, due to the excitation forces Fⱼ. In the second phase, the BE analysis of the acoustic cavity is performed in i.e. SYSNOISE by placing a volumetric velocity unit source at the point where the p/Fⱼ will be calculated. The pressure at the nodes of the BE mesh is taken as output. Thus, the p/vₖ transfer functions are calculated reciprocally. In the third phase the velocities from the first step and the p/vₖ from the second step are combined to calculate the p/Fⱼ amplitude and phase.

This technique provides some advantages in comparison to standard FE tools doing coupled vibro-acoustic calculations (like AKUSMOD). A first big advantage is that the first two steps are independent. If only the structure is modified, but the geometry of the passenger's compartment stays the same, the second step does not need to be repeated and vice versa. A second remarkable advantage is that the inner absorption of the panels in the passenger compartment can be taken into account locally, rather than through modal acoustic damping. Lastly, the contribution of the vibration body panels to the sound pressure can be calculated very easily. The main approximation is that no two-directional coupling is taken into account. In addition it can be that the BE element computation is time consuming. However, it should also be considered that the BE calculation is done only once and, if required, it can be replaced with an acoustic FE calculation.

The optimisation process can be easily customised, with the possibility of choosing a set of pre-defined targets. The user-can directly modify any of the above optimisation targets separately or choose any combination of them just by changing some command lines contained into a simple text interface file. It is also possible to give priority to a special target instead of another. This enables the achievement of the best compromise between weight reduction and NVH performance improvement (either structural vibration or SPL), according to the particular constraints the user wants to apply.

Two different algorithms are embedded into the GOLD optimisation toolbox:
The Standard Genetic Algorithm works on a relatively large population and converges with a more regular slope to the best solution.
The Micro Genetic Algorithm allows many generations on a much smaller population. It converges fast into a domain containing good solutions, then the slope of the OF curve decreases considerably.

The efficiency and versatility of GOLD makes it easy to be applied to a wide range of damping optimisation problems involving simple test cases, automotive components or vehicle bodies. In the following a few typical examples are discussed:

Damping Optimisation on Flat Rectangular Plate

The very first time, the GOLD optimisation toolbox was applied to a relatively simple test case. The test structure was a free-free steel flat rectangular plate, size 800 by 500 mm and 2 mm thick. A FE model of the plate was made first. Then the Mean Square Velocity (MSV) response of the plate carrying a given reference damping treatment configuration was calculated. 14 output points were randomly spread over the' plate surface, after assessing that this was enough to well characterise the MSV response of the test structure. The excitation was a unit point force applied in a corner and perpendicular to the plate surface. The reference damping treatment was a 2 mm thick layer of damping material on the whole plate surface. After that, the surface of the plate was subdivided into 16 possible rectangular damping patches, all with the same surface size.

GOLD was then used to perform a multi-objective optimisation on the plate and to find a new predicted optimised damping package giving lower MSV response levels and at least 20% lower weight than the reference damping treatment. Temperature was not considered as a variable in this case and was fixed at standard room temperature. For each patch, GOLD could choose among four different configurations: bare, 2 mm, 4 mm and 6 mm damping. The genetic algorithm optimisation by GOLD could achieve an optimum distribution of damping patches with two different thicknesses on the plate: 2 and 6 mm damping. GOLD managed to achieve significant improvements in the vibration behaviour of the plate with a contemporary 23% damping weight reduction in comparison with the initial treatment. The optimum damping package predicted by GOLD was then experimentally built up and measured. In the experimental set-up the plate was hung in order to reproduce free-free boundary conditions and was excited with white noise by a shaker in the same location and direction as the FE model, while small low-mass accelerometers were used for the output signal acquisition.

The improvement in the MSV response predicted by the optimisation for the lighter optimised damping package could be experimentally verified, i.e. by comparing the is values of the FE model and experimental set-up of the plate carrying the optimised damping package, together with the simulated and measured MSV responses. It can be seen that the experiments clearly confirmed that the prediction of MSV-reduction made by GOLD was correct.

Damping Optimisation on Vehicle Component

This GOLD application case on a vehicle component was the next step after the first validation case on the flat plate. The component was a part of a real vehicle floor with simplified boundary conditions. Its vibration response was firstly calculated taking into account the original damping treatment. Comparative measurements of the untreated component for the same boundary and excitation conditions showed that the simulation was well able to reproduce the vibration pattems. In particular, it was important to assess that the areas with high vibration levels were the same in measurement and simulation, even though the levels did not perfectly match. GOLD was then used to perform the damping treatment optimisation on the component and find a new predicted optimised damping package giving improved vibration results, i.e. lower MSV levels, than the original reference damping treatment, keeping the same damping mass. The possible damping areas on the floor (areas which are possible candidates to apply damping treatment) were subdivided into 15 potential damping patches. For each allowed configuration of metal sheet thickness, damping type and thickness, a set of different input material properties for GOLD was created. Each patch could be left bare or carry three possible treatment configurations, which means that the total number of possible solutions of the optimisation problem was 4¹⁵≈1.1·10⁹.

In order to reach convergence of the optimisation on reasonable calculation time, the Micro Genetic Algorithm was applied first on a reduced population of five individuals. After a sufficient number of generals, when an asymptotic behaviour of the Objective Function was reached, the Micro Algorithm was stopped, after about 1 hour. The population of individuals obtained at this step was used as input to the Standard Genetic Algorithm, which was run with a population of 30 individuals and 40 generations. After the GOLD run, which in total lasted just 10 hours, the distribution and mean square velocity response of the optimised solution could be examined. The optimum distribution consists of 11 treated patches out of the 15 possible candidates. Significant improvements in the mean square velocity vibration response could be predicted. After that, the predicted optimised damping package was manufactured on the real vehicle component and an experimental verification performed. Even though in this case some discrepancies between the simulation and experimental untreated component vibration levels was found, probably due to inaccurate modelling of the structure, the experiments confirm that the predicted damping package by GOLD performs globally better than the original reference package.

The potential of GOLD for the spatial optimisation of damping treatments was also tested against a non-automated iteration of the “trial-and-error” kind. The “manual” optimisation loops, mainly based on the experience of the user, allowed to find area and thickness distributions of the treatment with a little better mean square velocity response than the initial damping package. However, after a few days of calculations, the manual optimisation could not lead to any further vibration response improvement and still the optimised response was worse than GOLD. This can give a rough idea of the high efficiency of the automatic GOLD opfimisation process compared to standard man-driven optimisation techniques.

Damping Optimisation on Vehicle Body Panels

A real vehicle application example of GOLD is a damping optimisation performed on an upper class limousine car body. On this vehicle model a multi-objective damping treatment optimisation was performed in order to improve the vibration behaviour on the front floor while reducing the damping treatment mass by at least 30% with respect to the original damping package.

Calculations on the whole car body and on the floor, using a substructuring technique to model the remaining car body parts, were performed. In this way, more realistic boundary conditions can be applied to the panels (modal constraints at the nodes). In this particular test application a vertical unit displacement excitation was used.

Firstly, the FE model of the panels without any damping treatment was validated against a set of measurements and the general good correspondence of the simulated panel vibration responses with the measured ones was positively verified. After this initial validation step, a FE calculation with the original damping treatment of the vehicle was performed and the MSV response extracted and used as the reference case which the optimisation had to improve.

The damping areas (areas which were possible candidates to apply damping treatment) were divided into 17 potential damping patches. During the optimisation, each patch is allowed either to stay bare or to carry one out of seven possible different damping treatments (different materials and thicknesses).

The metal sheet thicknesses of the floor panels were given and different temperature areas for the dash, tunnel, front and rear floor regions were taken into consideration. In general, damping materials are strongly temperature dependent, thus the same treatment laying over panel areas with different temperatures has different mechanical properties: this behaviour is correctly taken into account by GOLD. In fact, it is possible to consider the same patch physically consisting of several sections having different thickness and/or temperature.

A set of different input material properties for GOLD were created per each allowed configuration of:
metal sheet thickness
damping thickness
damping material
temperature

The optimisation domain given by the 8 possible treatment configurations with 17 patches is made by 8¹⁷≈2.25·10¹⁵ possible solutions of the optimisation problem. Of course, this figure includes all authorised configurations for the optimisation, some of which can be unrealistic, like for example “all 17 patches bare” or “all patches treated with the highest treatment thickness”.

In order to reach a good convergence of the optimisation in reasonable calculation time, the Micro Genetic Algorithm was applied first on a reduced population of five individuals with a high number of possible generations allowed. After the 67^{th} generation a flattening of the slope of the. Objective Function versus the number of performed generations was remarked, so the Micro Algorithm was stopped at that generation, after about 30 minutes. The population of individuals obtained with these steps was used as input to the Standard Genetic Algorithm, which was run with a population of 60 individuals and 120 generations.

After the GOLD run, the best solutions according to the optimisation criteria were listed and the optimised solution could be extracted. That solution consists of seven treated patches (out of the 17 possible candidates). Significant improvements of the MSV average and peak levels were achieved, together with 33% weight reduction of the floor damping treatment with respect to the original treatment. When comparing the initial and optimised MSV curves, three frequency domains with different efficiency of the damping treatment can be identified:
below 100 Hz, no local panel modes exist, so there is in practice no vibration reduction/damping effect of the treatment and thus there can be no improvement anyhow due to damping application
between 100 Hz and 175 Hz a moderate effect due to damping is visible
above 175 Hz, important improvements are achieved, especially near the mode peaks (up to 5 and more dB)

With the described strategy, a huge optimisation space of 8¹⁷ possibilities could be efficiently explored performing 173 Nastran runs: this meant in total 33 hours of elapsed calculation time on a standard Unix workstation. The gains in the number of explored solutions and calculation time are enormous with respect to standard DOE techniques. In order to verify the prediction, together with the above GOLD optimisation, also an experimental optimisation of the damping package was performed by the Diamonds methodology on the real vehicle. The experimental optimisation process led to select the same damping material on the same vehicle panels with almost the same topological distribution of the treatment. However, a prototype of the vehicle is needed to carry out the hybrid experimental-numerial Diamonds optimisation, while GOLD is a purely numerical procedure, which can be applied before any prototye has been made available.

The present invention can be summarised as follows:

The typical structures considered when applying this tool are vehicle body FE models. The vibration dynamic performances of these models are typically simulated with commercial FE codes (MSC Nastran) that rely on the descretization of the geometrical domain and solve numerically the wave equation in the frequency domain

The numerical analysis methods most used to evaluate acoustic performances (Sound pressure level SPL, and acoustical transfer functions p/F) are various forms of Boundary Element Methods or Finite Element Methods (such as MSC Nastran).

Genetic Algorithms, have been widely employed to support the engineering design of structural components, with respect to different design purposes: static analysis, fluid dynamic analysis, and so on.

Typical quantities evaluated in the automotive industry for NVH purposes are frequency response functions (FRFs) of single points or various way of averaging FRFs by panel surfaces.

The application of damping layers is nowadays a widespread practice in the automotive industry to improve the dynamic properties of vehicle body panels, and the NVH characteristic of the passenger compartments.

The application of stiffenings and reinforcements (such as ribs, embossmetns, soap film layouts) on vehicle body panels is nowadays a widespred practie in the automotive industry to improve the dynamic properties of vehicle body panels, and the NVH characteristic of the passenger compartments.

It is an object of the present invention to provide a method to identify, at the same time, the optimal damping treatment and surface shape layout inside a structural FE component (typically vehicle body panels) considering as design variables of the problem, multiple damping positions over the structure, different damping materials, different thickness values per each material and multiple shape modificatios of the component surfaces (like ribs, embossments, soap film layouts).

It is also an object of the present invention to provide a method that can handle in a fast and efficient way the optimisation of large FE structures and taking into account high number of design parameters.

It is also an object of the present invention to provide a method that enables the fast simulation and update of the Finite Element Models, with different damping layer and geometrical surface layouts. This is possible through the following steps:
Definition of the areas where a damping treatment is to be applied
Definition of the surfaces where a shape modificaiton can be performed, and identification of the main dimensions of the geometrical layout of the shape change (for example: length and width and height of a rib extrusion)
Definition per each areas of the damping layout and temperature conditions, evaluation of the Equivalent Material properties through Emerald
Automatically update each panel/area of the FE model with the corresponding computed Equivalent Material Properties
Automatically update each surfaces with the corresponding shape layout modification

One or more methods of the invention enables the optimisation of the vibrational behaviour of the FE component. This is possible through the following steps:
Definition of the loading conditions
Definition of structural response nodes over the panels/structure, which are part of the Objective Function of the optimisation algorithm
Evaluation of the dynamic behaviour a “Reference damping treatment and shape layout configuration” over the surfaces of the component/vehicle, through a FE dynamic solution
The results of the calculation of the reference configuration are several different quantities: treatment intrinsic properties (weight, cost, etc.) structural response average, structural response transfer function. Those quantities can be used as optimisation target/constraint
Qualitatively analyse the improvement, compared to the reference configuration, of each configuration explored by the optimization algorithm

One or more methods of the invention enables the optimisation of the acoustic behaviour (SPL, p/F) of the component. This is possible through the following steps:
Definition of the loading conditions
Definition of structural response nodes over the panels/structure, which are part of the Objective Function of the optimisation algorithm
Evaluation of the dynamic behaviour a “Reference damping treatment and shape layout configuration” over the surfaces of the component/vehicle, through a FE dynamic solution, the component/vehicle, through a FE dynamic solution, obtaining frequency response functions.
Definition of the points at which that acoustic quantity has to be evaluated
Construction of the acoustic mesh in addition to the structural and computation of the acoustic performances (through Finite Elements or Boundary Elements) of the “Reference damping treatment and shape layout configuration”, coupling the structural and the acoustic FRFs
The results of the calculation of the reference configuration are several different quantities: treatment intrinsic properties (weight, cost, etc.), acoustic response average, acoustic response transfer function. Those quantities can be used as optimisation target/constraint.
Qualitatively analyse the improvement, compared to the reference configuration, of each configuration explored by the optimisation algorithm.

The invention consists in one aspect in a new methodology to increase the complexity and the number of design variables taken into account during a damlping treatment and geometrical shape layout optimisation problem of structural panels for NVH purposes. The design variables can be:
Multiple location of the damping pads over the structure surface
Several different damping/panel materials
Different thickness values per each damping/panel material
Multiple locations of shape modifications of the structure surface
Main dimensions of each shape modification

This high number of variables can be handled through the application of a Genetic Algorithm. This algorithm contains routines capable of updating FE models with new structural shape and damping layout, and once the optimisation strategy of the algorithm is specified, the user is able to choose and customise several different Objective Function types, based on different quantities. These can be NVH response and/or intrinsic characteristics of the treatment (weight, cost, etc.). Each of those quantities can be independently considered as target or constrained to the values of a “Reference damping treatment and shape layout configuration”. In alternative, two or more of them can be combined according to different levels of importance, as the user wishes. That means, different quantities can be combined and each of them can be given a defined priority on the others and/or a defined assigned value and/or range to be uses as a target/constrain. In order to be able to perform this operation the user has to perform the following preparation steps:
Definition of the loading conditions
Definition of the zones where damping material treatments can be potentially applied (called “Patches”)
Definition of the possible panel treatments which the algorithm can use for the optimisation
Definition of the areas, on the structure surface, where a shape modification can be potentially applied
Definition of the range of main dimensions per each potential shape modification which the algorithm can tr to apply during the optimisation
Computation of all the equivalent material properties, per each combination of a possible tretments, plus per each panel structure thickness and temperature (through Emerald)
Definition and evaluation of the “Reference configuration” of the model for what concerns its damping treatment layout and its surfaces shape layout

The herewith mentioned method “MSC Nastran” is a well-known and commercial available software that belongs to the category of Finite Element discretisation methods. This method relies upon the discretisation of the geometrical domain; it buids up matrices (for the stiffness, the mass and damping) describing the relation among the points (nodes), discretising the structure, and it involves, numerically, the wave equations in the frequency domain. There exists substantial published literature concerning both theoretical and practical aspects of this numerical method, i.e. H. Kardestuncer, D. H. Norrie: “Finite Element Handbook”, McGraw-Hill Book Company, MCS Software, Nastran quick reference guide.

The herewith mentioned EMERALD (Equivalent Material Evaluation for the Refinement and Allocation of Layered Damping) method is a well-known numerical tool aimed to the accurate representation of damping materials in Finite Element body structures (such as vehicle bodies). According to this method the treated region of the structure is represented as an imaginary equivalent material, described by a set of mechanical properties instead of the pure steel properties for the bare case. By “equivalent material”, one should understand a hpothtical homogeneous material that has the same properies as the real, anisotropic multiplelayer material for a given deformation type.

The advantages of present invention are obvious for the man skilled in the art. GOLD is a new optimisation tool developed by applicant, based on a genetic algorithms and able to efficiently predict the optimum damping package on vehicle body panels in terms of materials, thickness and local damping distribution. GOLD allows the efficient exploration of very large solution
domains and has the possibility of taking into account high numbers of variables, even in full vehicle computations (metal sheet and damping treatment type, thickness, temperature and distribution). It has been successfully tested in different test cases, from simple plates to full vehicle applications. With its wide choice of algorithms and customisation functionality, it allows the definition of a wide range of optimisation strategies, according to the specific user needs (weight reduction, vibration reduction, improvement of the acoustics, improvement for a specific frequency range, etc.). The GOLD has an open architecture, which makes it easy to modify and link to any simulation methodology. It is compatible, for instance, with all MSC Nastran® features, in particular sub-structuring techniques (superelements) and modal superposition calculations.

GOLD helps the achievement of the optimum in the design of vehicle damping packages by means of FE simulation. It is based on generic algorithms, which are recognised as the most powerful methodology to handle complex optimisation problems with a very large number of variables (possibly discontinuous). The optimisation is performed in a cascade of successive iterations. In each iteration a set of solutions is explored and the best are selected on the basis of certain given constraints: lower vibration, lighter weight, lower SPL. Each time a new iteration is performed, the population evolves for the better; the best solutions are kept in the selection process and can generate new solutions, while the worst are discarded and replaced with the new ones. The whole iteration and generation process is automatically performed and controlled by special operators embedded in the GOLD software, which is written in MatLab® software package.

The user is free to customise the damping package optimisation by directly pre-setting the optimisation constraints with simple interface commands. The user also has the possibility of monitoring the optimisation process on a visual control panel, where the state of the optimisation flow is shown in real time, iteration by iteration. One of the main features of GOLD is that the number of input variables cari be very high. The user can take into account many different materials, distributions and thicknesses of metal and damping, as well as different temperature areas in the damping package.

1. Optimisation and simulation CAE-method for determining optimal damping treatments layouts within structural body parts of vehicles, in particular structural body frames, comprising the following input steps to create input variables:
generating a structural finite element (FE) model of the vehicle body on which damping has to be optimised;
defining a plurality (N) of possible damping treatments and determining its material characteristic data as well as the body material characteristic data;
and further comprising the following computing steps:
applying a genetic algorithm to the above input variables, which algorithm performs a selective iteration by:
a) generating a pool of individuals (damping packages/treatment configuration, coded by a binary string) from the input variables (equivalent material damping properties, spatial distribution, thickness, weight, etc. of the binary string);
b) mutating (bit change for an individual)and/or crossing (exchange of bit sequences) randomly selected individuals/genes of this pool by means of genetic statistic operators to generate a new generation of individuals/genes;
c) selecting each individual of the new generation by means of a statistical selection according to a defined objective function (OF), i.e. calculating the value of a predetermined fitness/priority criterium/predefined targets (lower weight, lower vibration, lower sound pressure level, lower cost, etc./objective function);
d) correlating individual's chance of mutating and/or crossing with their performance with respect to the objective function;
e) mutating and/or crossing these chance-correlated individuals by means of genetic statistic operators to generate a next new generation of individuals;
f) iterating steps c), d) and e) until a predetermined flattening of the slope of the OF versus the number of performed generations is achieved, which leads to a set of optimised vibration damping configurations,
characterised in that this method further comprises the following input steps to create input variables:
generating further structural finite element (FE) model of the vehicle body comprising structural vehicle body frames and/or panels such as dash, floor or tunnel, on which damping has to be optimised and—in case that an acoustic target/SPL is required—generating a boundary element (BE) model of the passenger compartment;
defining damping patches potentially subject to possible treatment; defining the plurality (N) of possible damping treatments by including no treatment; and further comprising the following computing steps:
Computing the equivalent material damping properties, in particular the overall thickness, weight, porosity, bending-stiffness, elongation stiffness, bending loss factor, elongation loss factor, visco-elasticity, temperature, etc.) by multi-layer simulation, for instance by EMERALD), from these material properties for each combination of any of the plurality of the possible damping treatments with any of the vehicle body panel parameters, including the temperature and frequency dependency of all materials involved;
running a FEM simulation, a finite element model simulation, such as NASTRAN, for a reference configuration in order to calculate the dynamic response in the frequency domain (in particular by using the NVH response transfer function), in particular the vibration behaviour of the vehicle on which damping has to be optimised with respect to excitation, architecture/structure and used materials.

2. Method in accordance with claim 1, characterised in that it relates also to panel shape layouts within structural body parts of vehicles, in particular to determining optimal panel shape layouts within structural panels subjected to structural loads, i.e. determining the optimal geometrical shape layouts of the vehicle body panels under a predefined loading condition, further comprising the following steps:
defining the areas where a damping treatment is to be applied;
defining the surfaces where a shape modification can be performed, and identification of the main dimensions of the geometrical layout of the shape change;
defining per each areas of the damping layout and temperature conditions and evaluating of the Equivalent Material properties through Emerald; automatically updating each panel/area of the FE model with the corresponding computed Equivalent Material Properties;
automatically updating each surfaces with the corresponding shape layout modification.

3. Method in accordance with claim 1, characterised in that this method comprises further steps of defining additional constraints or objectives in terms of weight and noise vibration harsh (NVH) performance, in particular in vibration and acoustic pressure.

4. Method in accordance with claim 2, characterised in that this method comprises further steps of defining additional constraints or objectives in terms of weight and noise vibration harsh (NVH) performance, in particular in vibration and acoustic pressure.
